(19) United States
(12) Patent Application Publication
(10) Pub. No.: US 2026/0059546 A1
(43) Pub. Date: Feb. 26, 2026

(54) TRANSMITTING ADVERTISEMENT MESSAGES THAT INDICATE SIDELINK RESERVATIONS

(71) Applicant: QUALCOMM Incorporated, San Diego, CA (US)

(72) Inventors: Mohammed JABI, San Diego, CA (US); Tugcan AKTAS, La Jolla, CA (US)

(21) Appl. No.: 18/810,910

(22) Filed: Aug. 21, 2024

(51) Int. Cl. H04W 72/25; H04W 72/02

(52) U.S. Cl. CPC H04W 72/25; H04W 72/02

(57) ABSTRACT

Various aspects of the present disclosure generally relate to wireless communication. In some aspects, a first user equipment (UE) may generate a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations. The UE may transmit the message to a second UE. Numerous other aspects are described.

### FIELD OF THE DISCLOSURE

Aspects of the present disclosure generally relate to wireless communication and specifically relate to techniques, apparatuses, and methods for transmitting advertisement messages that indicate sidelink reservations.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some implementations, an apparatus for wireless communication at a first user equipment (UE) includes one or more memories; and one or more processors, coupled to the one or more memories, configured to cause the first UE to: generate a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and transmit the message to a second UE.

In some implementations, an apparatus for wireless communication at a second UE includes one or more memories; and one or more processors, coupled to the one or more memories, configured to cause the second UE to: receive, from a first UE, a message that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations; and transmit, to the first UE or to a third UE, a sidelink transmission based at least in part on the message.

In some implementations, a method of wireless communication performed by a first UE includes generating a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and transmitting the message to a second UE.

In some implementations, a method of wireless communication performed by a second UE includes receiving, from a first UE, a message that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations; and transmitting, to the first UE or to a third UE, a sidelink transmission based at least in part on the message.

In some implementations, a non-transitory computer-readable medium storing a set of instructions for wireless communication includes one or more instructions that, when executed by one or more processors of a first UE, cause the first UE to: generate a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and transmit the message to a second UE.

In some implementations, a non-transitory computer-readable medium storing a set of instructions for wireless communication includes one or more instructions that, when executed by one or more processors of a second UE, cause the second UE to: receive, from a first UE, a message that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations; and transmit, to the first UE or to a third UE, a sidelink transmission based at least in part on the message.

In some implementations, a first apparatus for wireless communication includes means for generating a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and means for transmitting the message to a second UE.

In some implementations, a second apparatus for wireless communication includes means for receiving, from a first UE, a message that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations; and means for transmitting, to the first apparatus or to a third apparatus, a sidelink transmission based at least in part on the message.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a hidden node scenario, in accordance with the present disclosure.

FIG. 5 is a diagram illustrating an example of inter-UE coordination, in accordance with the present disclosure.

FIG. 6 is a diagram illustrating an example of inter-UE coordination information, in accordance with the present disclosure.

FIG. 7 is a diagram illustrating an example of an evolution of a list of reservations tracked by a UE over a period of time, in accordance with the present disclosure.

FIGS. 8-12 are diagrams illustrating examples associated with transmitting advertisement messages that indicate tracked sidelink reservations, in accordance with the present disclosure.

FIGS. 13-14 are diagrams illustrating example processes associated with transmitting advertisement messages that indicate tracked sidelink reservations, in accordance with the present disclosure.

FIGS. 15-16 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

For a New Radio (NR) sidelink communication, sidelink transmission resources may be set using one of two modes. In a first resource allocation mode (Mode 1), a network (e.g., an overlaid network) may schedule sidelink transmissions. In a second resource allocation mode (Mode 2), user equipments (UEs) involved in sidelink communications may autonomously decide on resources to use based at least in part on sensing, a resource selection procedure, and/or resource (or resources) reservation announcements. In Mode 2, current slot resource reservation information may be announced to other UEs as part of a first stage sidelink control information (SCI). In addition, a UE may also reserve resources for up to two additional transmissions within a time window of 32 slots. The UE may be able to reserve periodically occurring sets of resources. Each occurrence may be a replica of an initial reservation, composed of a maximum of three resources. A resource reservation period may range from 1 ms to 1000 ms, and the resource reservation period may be indicated in the first stage SCI.

A sidelink UE may support inter-UE coordination in Mode 2, where the sidelink UE may transmit inter-UE coordination information regarding resources to a peer UE. The peer UE may use the inter-UE coordination information for resource selection or resource reselection. A first scheme or a second scheme of inter-UE coordination may be supported. In the first scheme, the inter-UE coordination information transmitted from the sidelink UE to the peer UE may indicate a preferred or non-preferred resource for the peer UE's transmission. In the second scheme, the inter-UE coordination information transmitted from the sidelink UE to the peer UE May indicate a presence of an expected/potential resource conflict on resources indicated by the peer UE's SCI.

However, the inter-UE coordination may be associated with a relatively large signaling overhead. The inter-UE coordination may indicate resources to be used by the sidelink UE and/or resources to be used by other peer UEs, which may result in the relatively large signaling overhead. The sidelink UE may need to indicate all resource reservation information each time an inter-UE coordination message is transmitted, and often the inter-UE coordination message may include resource reservation information that was already transmitted.

Various aspects relate generally to transmitting messages (also referred to as advertisement messages), that indicate tracked sidelink reservations. Some aspects more specifically relate to transmitting advertisement messages that indicate only changes to the tracked sidelink reservations. In some examples, a first UE may transmit, to a second UE, an advertisement message. The advertisement message may be an inter-UE coordination message. The advertisement message may indicate a reservation overview element (ROE) (also referred to as an ROE field). The ROE may include a set ID associated with a set of tracked sidelink reservations that are tracked by the first UE. The ROE may include a bitmap that advertises changes to a subset in the set of tracked sidelink reservations. The advertisement message may optionally include at least one reservation detail element (RDE) (also referred to as an RDE field). In some cases, the advertisement message may not include any RDE (e.g., the advertisement message may include zero RDEs). In other cases, the advertisement message may include one or multiple RDEs. The RDE may include a subset ID associated with the subset. The RDE may include information related to all sidelinks in a particular subset, such that the RDE may be transmitted once when a specific subset is formed. The advertisement message may indicate both the ROE and the RDE in response to a new sidelink reservation being added to the set of tracked sidelink reservations, or the advertisement message may indicate both the ROE and the RDE in response to a tracked sidelink reservation being deleted or no longer active. Alternatively, the advertisement message may not indicate the RDE in response to no new sidelink reservation being added to the set of tracked sidelink reservations. The advertisement message may not indicate information related to certain sidelink reservations when the sidelink reservations are active and the information was already transmitted in a previous advertisement message. The advertisement message may be associated with sidelink reservations for which the first UE is a source or a destination, and/or the advertisement message may be associated with sidelink reservations for which the second UE is a source or a destination. In other words, the sidelink reservations advertised may be sidelinks in which a neighbor UE of the first UE (e.g., the second UE) is the source or the destination.

Particular aspects of the subject matter described in this disclosure can be implemented to realize one or more of the following potential advantages. In some examples, by transmitting advertisement messages that advertise changes to subsets in a set of tracked sidelink reservations, the described techniques can be used to reduce a signaling overhead. The first UE may not transmit an entire list of tracked reservations each time, but rather may only transmit changes to the tracked reservations. Neighbor UEs that receive an advertisement message may compare the advertisement message with previous advertisement messages to determine whether new reservations have been added or old reservations have been removed. As a result, an overhead generated by the first UE when notifying the neighbor UEs of the sidelink reservations that the first UE is tracking may be reduced, thereby improving an overall system performance. Multiple-access radio access technologies (RATs) have been adopted in

various telecommunication standards to provide common protocols that enable wireless communication devices to communicate on a municipal, enterprise, national, regional, or global level. For example, 5G NR is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

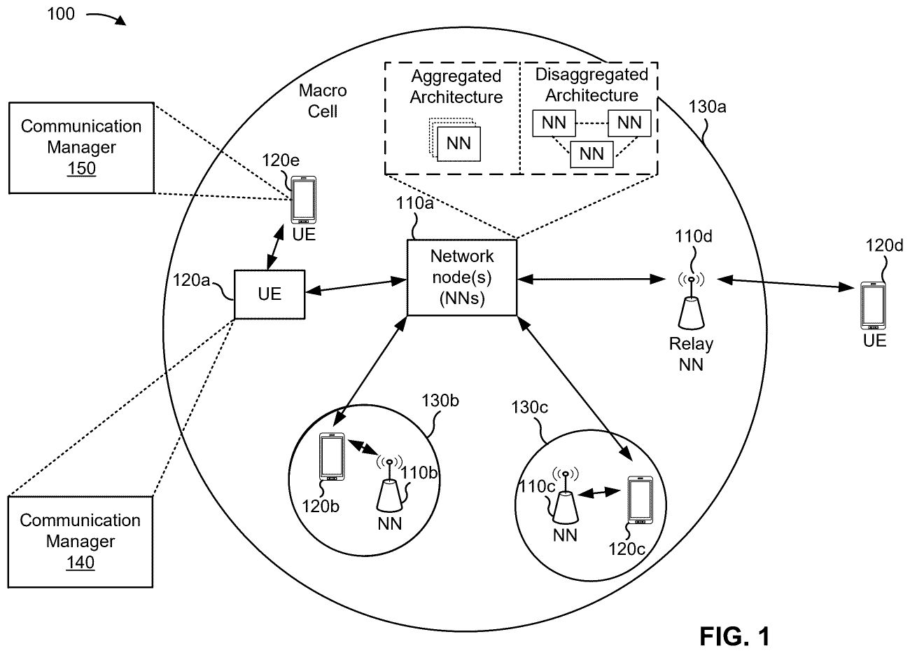

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a first UE (e.g., UE 120a) may include a communication manager 140. As described in more detail elsewhere herein, the communication manager 140 may generate a message (e.g., an advertisement message) for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and transmit the message to a second UE. Additionally, or alternatively, the communication manager 140 may perform one or more other operations described herein.

In some aspects, a second UE (e.g., UE 120e) may include a communication manager 150. As described in more detail elsewhere herein, the communication manager 150 may receive, from a first UE, a message (e.g., an advertisement message) that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations; and transmit, to the first UE or to a third UE, a sidelink transmission based at least in part on the message. Additionally, or alternatively, the communication manager 150 may perform one or more other operations described herein.

As indicated above, FIG. 1 is provided as an example. Other examples may differ from what is described with regard to FIG. 1.

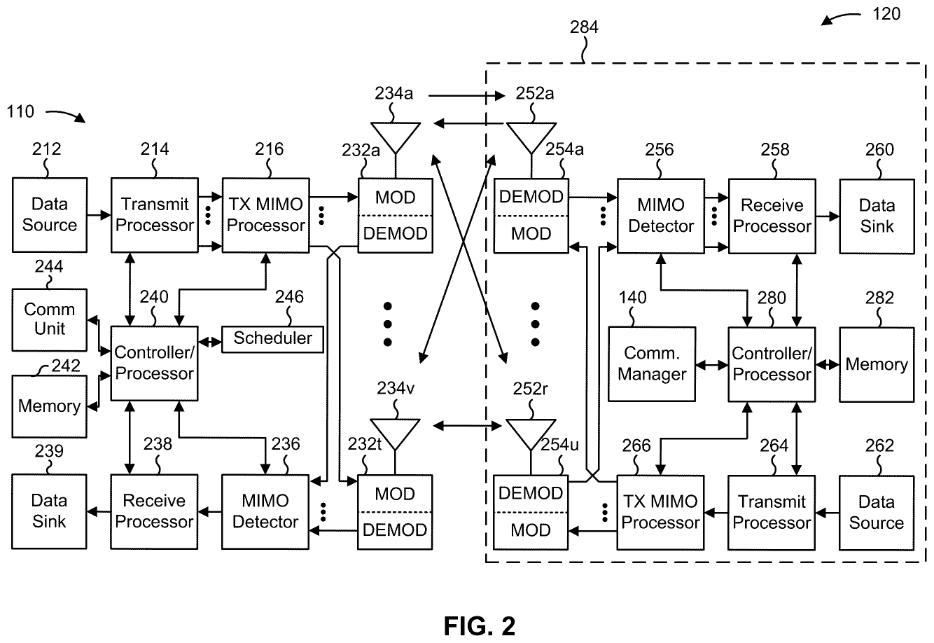

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

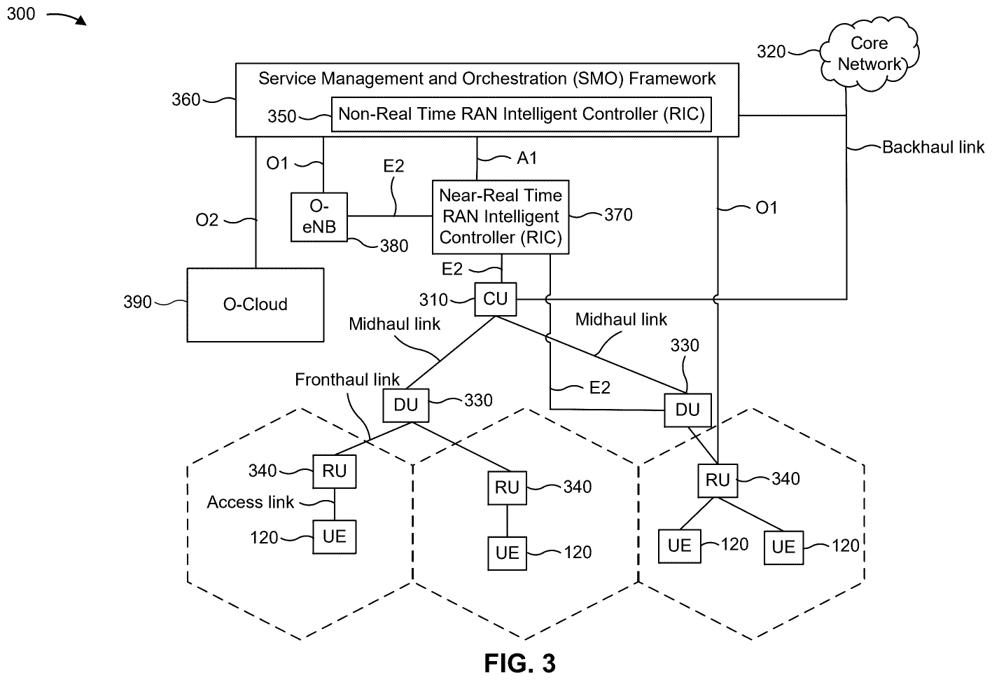

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

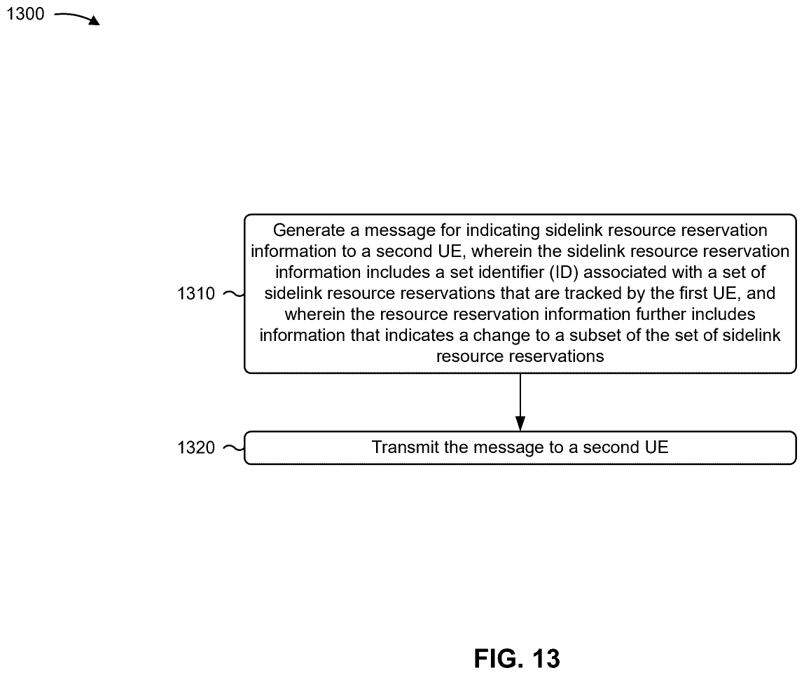

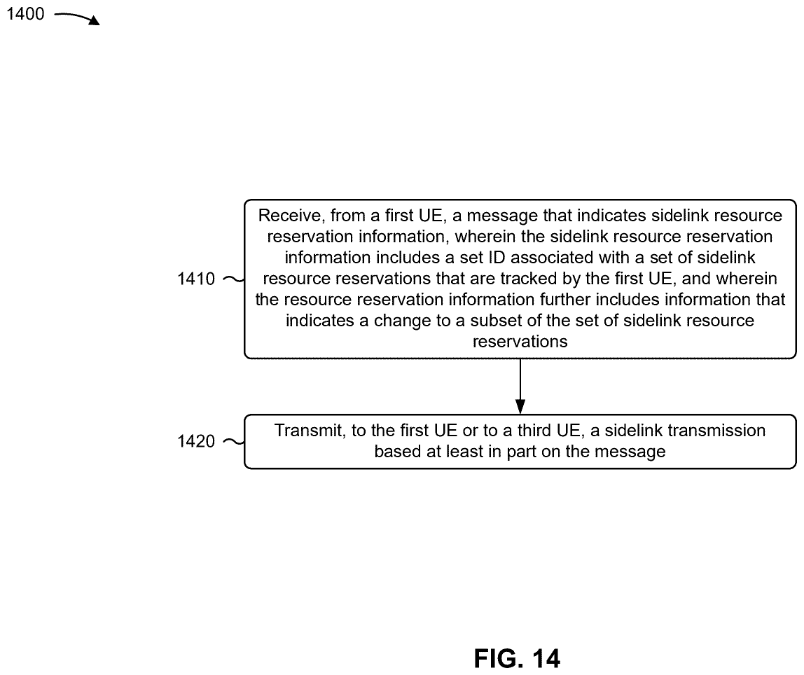

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with transmitting advertisement messages that indicate tracked sidelink reservations, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1300 of FIG. 13, process 1400 of FIG. 14, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13, process 1400 of FIG. 14, or other processes as described herein. In some examples, executing instructions may include running the instructions, converting the instructions, compiling the instructions, and/or interpreting the instructions, among other examples.

In some aspects, a first UE (e.g., UE 120a) includes means for generating a message (e.g., an advertisement message) for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and/or means for transmitting the message to a second UE. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first UE (e.g., UE 120c) includes means for receiving, from a first UE, a message that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations; and/or means for transmitting, to the first UE or to a third UE, a sidelink transmission based at least in part on the message. The means for the second UE to perform operations described herein may include, for example, one or more of communication manager 150, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

For an NR sidelink communication, sidelink transmission resources may be set using one of two modes. In a first resource allocation mode (Mode 1), a network (e.g., an overlaid network) may schedule sidelink transmissions. In a second resource allocation mode (Mode 2), UEs involved in sidelink communications may autonomously decide on resources to use based at least in part on sensing, a resource selection procedure, and/or resource (or resources) reservation announcements. In the second resource allocation mode, current slot resource reservation information may be announced to other UEs as part of a first stage SCI. In addition, a UE may also reserve resources for up to two additional transmissions within a time window of 32 slots. The UE may be able to reserve periodically occurring sets of resources. Each occurrence may be a replica of an initial reservation, composed of a maximum of three resources. A resource reservation period may range from 1 ms to 1000 ms, and the resource reservation period may be indicated in the first stage SCI.

The resource reservation announcements via the first stage SCI may aim to provide other UEs with information regarding which resource the UE has selected for a future sidelink transmission. The other UEs may then avoid transmitting or reserving those occupied resources. The resource reservation announcements may not be sufficient to guarantee full reliability. For example, the resource reservation announcements may not handle hidden node scenarios. Inter-UE coordination may be employed in sidelink communication to address certain deficiencies of the resource reservation announcements.

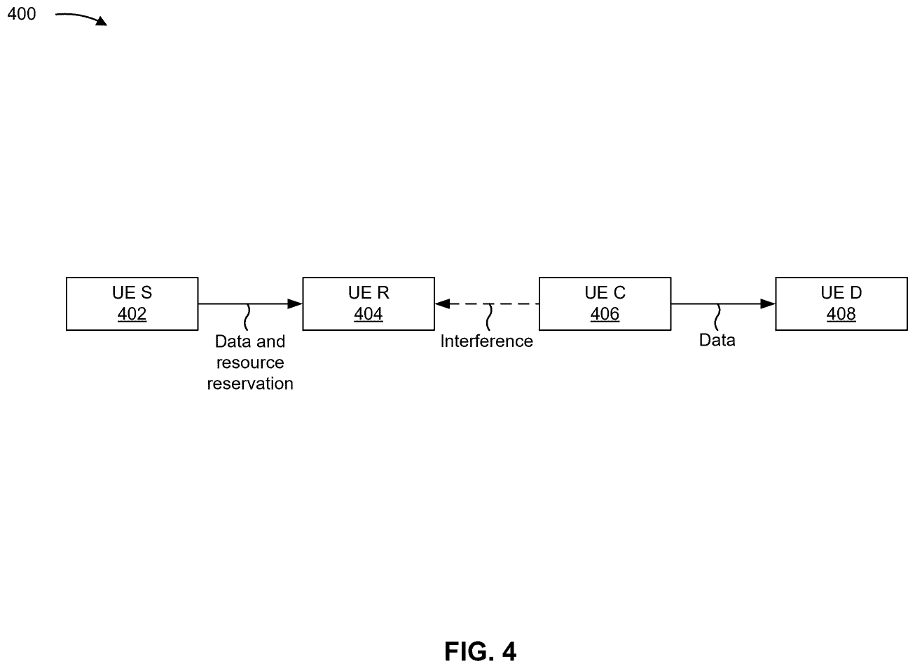

FIG. 4 is a diagram illustrating an example 400 of a hidden node scenario, in accordance with the present disclosure.

As shown in FIG. 4, UE S 402 may transmit data to UE R 404. UE S 402 may also indicate a resource reservation to UE R 404. UE S 402 may reserve a periodic set of resources to communicate with UE R 404, which may be indicated by the resource reservation. UE C 406 may not be able to decode a signal transmitted from UE S 402 (e.g., due to a distance between UE S 402 and UE C 406). Since UE C 406 is not capable of receiving a reservation message transmitted from UE S 402, UE C 406 may transmit data to UE D 408 when UE S 402 is transmitting to UE R 404. In this example, UE R 404 may be relatively close to UE C 406, and UE C 406 may cause interference to UE R 404. UE R 404 may not be able to decode data transmitted from UE S 402, even when a set of resources were reserved by UE S 402.

As indicated above, FIG. 4 is provided as an example. Other examples may differ from what is described with regard to FIG. 4.

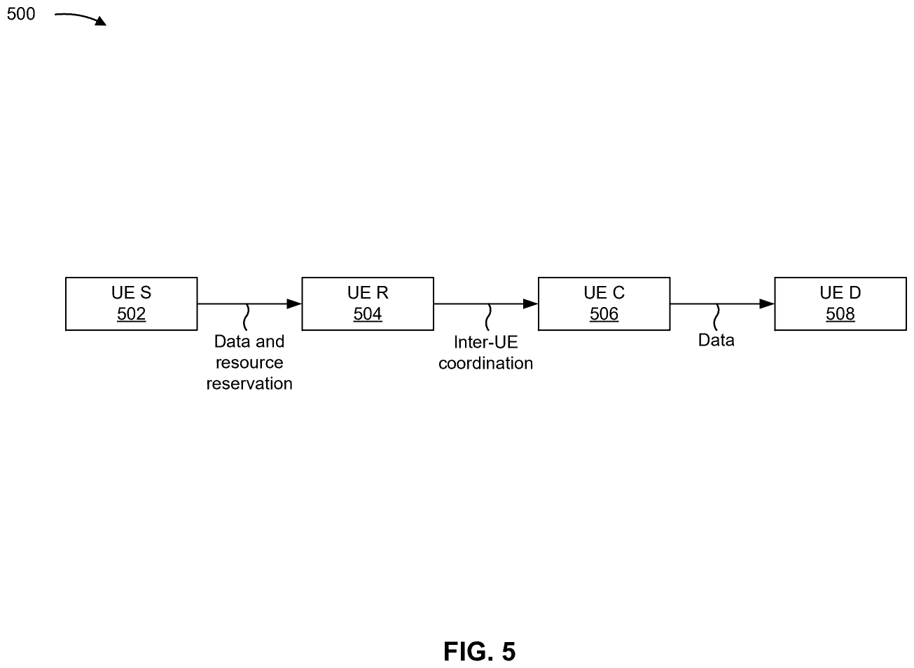

FIG. 5 is a diagram illustrating an example 500 of inter-UE coordination, in accordance with the present disclosure.

As shown in FIG. 5, with inter-UE coordination, UE R 504 may share with UE C 506 a set of resources reserved by neighbors of UE R 504 (e.g., UE S 502). In this way, UE C 506 may be aware of reserved slots, and UE C 506 may avoid causing any interference at UE R 504 when UE S 502 is communicating with UE R 504. UE C 506 may transmit data to UE D 508 in resources that are not already reserved by, for example, UE S 502, based at least in part on an inter-UE coordination message.

As indicated above, FIG. 5 is provided as an example. Other examples may differ from what is described with regard to FIG. 5.

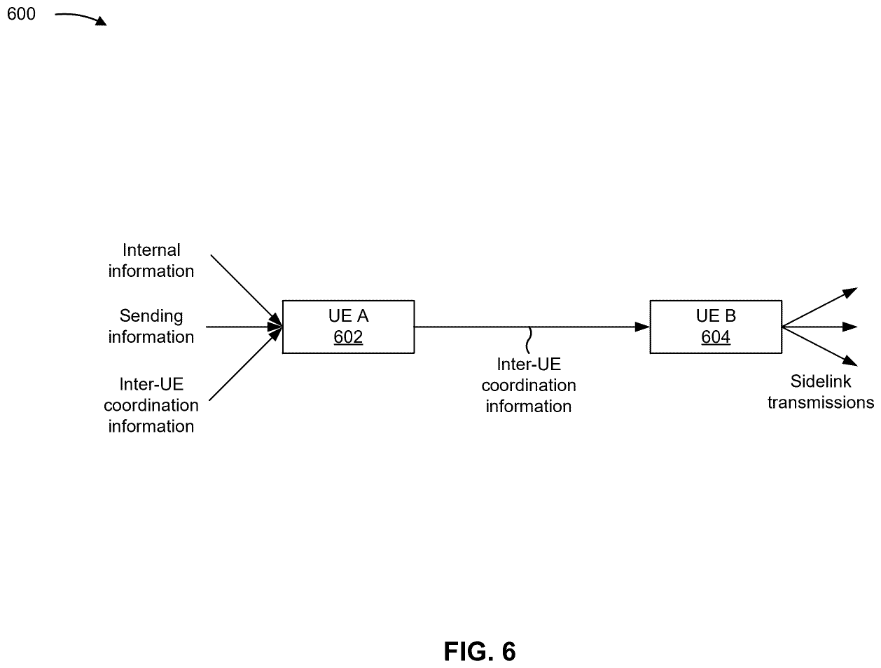

FIG. 6 is a diagram illustrating an example 600 of inter-UE coordination information, in accordance with the present disclosure.

Inter-UE coordination may be associated with a reliability enhancement, as inter-UE coordination may address hidden node and half-duplex scenarios. Two inter-UE coordination schemes may be defined. A first inter-UE coordination scheme may involve measurements to prevent or reduce collisions, and may involve preferred resources or non-preferred resources. A second inter-UE coordination scheme may involve an issue with a transmission, and may involve a detected conflict or an expected conflict. In some cases, a first UE (UE A) may specify, to a second UE (UE B), inter-UE coordination information that indicates resources to avoid, where such resources may be used by the first UE to transmit or receive, or such resources may already be reserved by a neighbor of the first UE.

As shown in FIG. 6, UE A 602 may identify internal information, sensing information, and/or the inter-UE coordination information. UE A 602 may transmit, to UE B 604, the inter-UE coordination information, which may indicate at least a portion of the internal information, the sensing information, and/or a portion of received inter-UE coordination information. UE B 604 may perform sidelink transmissions based at least in part on the inter-UE coordination information.

As indicated above, FIG. 6 is provided as an example. Other examples may differ from what is described with regard to FIG. 6.

A sidelink UE may support inter-UE coordination in Mode 2, where the sidelink UE may transmit inter-UE coordination information regarding resources to a peer UE. The peer UE may use the inter-UE coordination information for resource selection or resource reselection. A first scheme or a second scheme of inter-UE coordination may be supported. In the first scheme, the inter-UE coordination information transmitted from the sidelink UE to the peer UE may indicate a preferred or non-preferred resource for the peer UE's transmission. In the second scheme, the inter-UE coordination information transmitted from the sidelink UE to the peer UE may indicate a presence of an expected/potential resource conflict on resources indicated by the peer UE's SCI.

In the first scheme, a transmission of the inter-UE coordination information from the sidelink UE may be triggered by a condition at the sidelink UE, or by an explicit request from the peer UE. The sidelink UE may determine a set of resources reserved by other UEs, or the sidelink UE may determine slots where the sidelink UE, when the sidelink UE is an intended receiver of the peer UE, does not expect to perform a sidelink reception from the peer UE due to a half-duplex operation. The sidelink UE may use these resources as a set of non-preferred resources, or the sidelink UE may exclude these resources to determine a set of preferred resources. The sidelink UE may transmit an indication of the preferred or non-preferred resources to the peer UE. Regarding the inter-UE coordination information received from the sidelink UE, the peer UE's resources for resource selection or resource reselection may be based at least in part on peer UE sensing results (if available) and the inter-UE coordination information, or the peer UE's resources for resource selection or resource reselection may be based at least in part on only the inter-UE coordination information. For the first scheme, a MAC-CE and a second stage SCI or MAC-Ce only may be used to send the inter-UE coordination information. For an inter-UE coordination information transmission triggered by an explicit request, both the explicit request and the inter-UE coordination information may be transmitted in a unicast manner. For an inter-UE coordination information transmission triggered by a condition other than the explicit request, inter-UE coordination information indicating a preferred resources set may be transmitted in the unicast manner. Inter-UE coordination information indicating a non-preferred set may be transmitted in a unicast, groupcast, or broadcast manner.

In the second scheme, the sidelink UE may determine the expected/potential resource conflict within resources indicated by the peer UE's SCI as either resources reserved by other sidelink UEs and identified by the sidelink UE as fully or partially overlapping with the resources indicated by the peer UE's SCI, or as slots where the sidelink UE is an intended receiver of the peer UE and does not expect to perform sidelink reception on those slots due to a half-duplex operation. The peer UE may use the conflict resources to determine resources to be reselected and exclude the conflict resources from the reselected resources. For the second scheme, a PSFCH may be used to transmit the inter-UE coordination information.

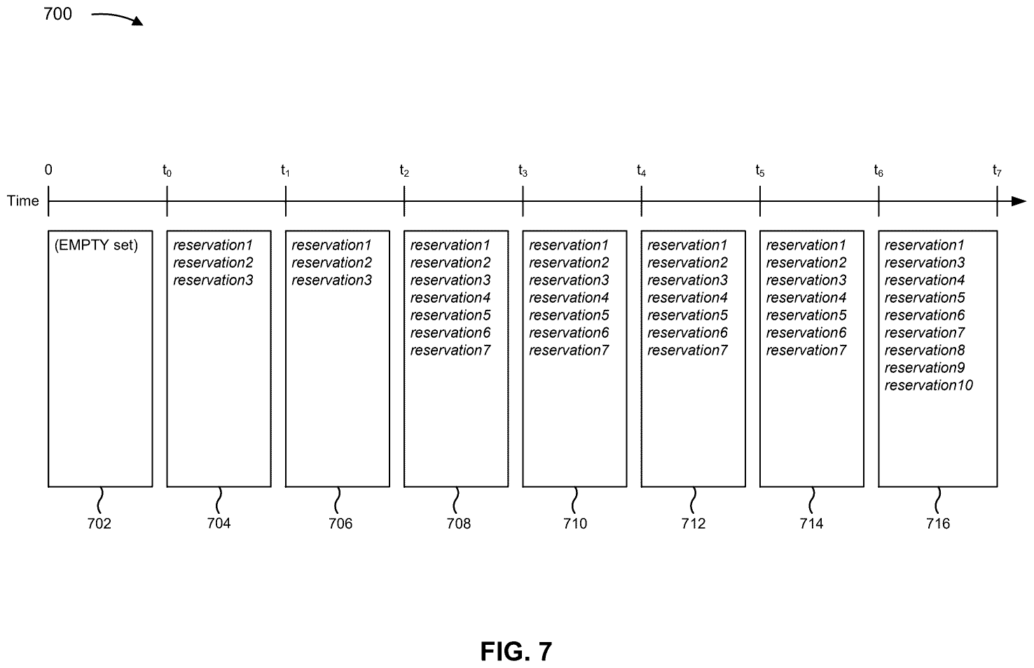

FIG. 7 is a diagram illustrating an example 700 of an evolution of a list of reservations tracked by a UE over a period of time, in accordance with the present disclosure.

As shown in FIG. 7, the UE may maintain a list of tracked reservations over a period of time (e.g., time 0 to time t₇ shown in FIG. 7). At time 0, the UE may start to track specific reservations. As shown by reference number 702, at time 0, the UE may track an empty set. As shown by reference number 704, at t₀, the UE may track reservation₁ to reservation₃. As shown by reference number 706, at t₁, the UE may track reservation₁ to reservation₃. As shown by reference number 708, at t₂, the UE may track reservation₁ to reservation₇. As shown by reference number 710, at t₃, the UE may track reservation₁ to reservation₇. As shown by reference number 712, at t₄, the UE may track reservation₁ to reservation₇. As shown by reference number 714, at t₅, the UE may track reservation₁ to reservation₇. As shown by reference number 716, at t₆, the UE may track reservation₁ to reservation₁₀. In some examples, each of the tracked reservations (e.g., reservation₁, reservation₂, etc.) may represent different sidelink resources (e.g., different time-frequency resources of a sidelink).

In some aspects, the UE may start tracking reservation₁ (shown as reservation₁ in FIG. 7) and reservation₄ after to and t₂, respectively. The UE may start tracking reservation₂ between to and t₇. The UE may indicate the list of tracked reservations in inter-UE coordination messages transmitted to other UEs, in order to advertise the reservations tracked by the UE in the case of Mode 2. At t₇, the list of tracked reservations may include reservation₁, reservation₃, reservation₄, reservations, reservation₆, reservation₇, reservation₈, reservation₉, and reservation₁₀. The inter-UE coordination messages may be associated with significant overhead, as the list of tracked reservations may grow over the period of time. Such increased overhead may consume resources at the UE and/or at a network node (e.g., compute resources and/or network resources), which may degrade an overall system performance.

As indicated above, FIG. 7 is provided as an example. Other examples may differ from what is described with regard to FIG. 7.

In various aspects of techniques and apparatuses described herein, a first UE may generate a message for indicating sidelink resource reservation information. The sidelink resource reservation information may include a set identifier (ID) (e.g., in an ROE as described herein) associated with a set of sidelink resource reservations that are tracked by the first UE. The resource reservation information may further include information (e.g., a bitmap in an ROE as described herein) that indicates a change to a subset of the set of sidelink resource reservations. The first UE may transmit the message to a second UE. In some aspects, the message may further includes information (e.g., in an RDE field as described herein) indicating an addition of at least one new sidelink resource reservation to the subset or a removal of an existing sidelink resource reservation from the subset. In some aspects, the message may exclude information indicating an addition of at least one new sidelink resource reservation to the subset based on whether a previous message transmitted to the second UE included the information indicating the addition of the at least one new sidelink resource reservation to the subset. In some aspects, the message may exclude the information indicating the addition of the at least one new sidelink resource reservation to the subset further based on whether the at least one new sidelink resource reservation is active.

In some aspects, the first UE may transmit, to the second UE, a message (also referred to as an advertisement message) for indicating sidelink resource reservation information. The advertisement message may be an inter-UE coordinate message. The advertisement message may indicate an ROE. The ROE may include a set ID associated with a set of tracked sidelink reservations that are tracked by the first UE. The ROE may include a bitmap that advertises changes to a subset in the set of tracked sidelink reservations. The advertisement message may indicate one or more RDEs. In some cases, the advertisement message may not include any RDEs (e.g., the advertisement message may indicate zero RDEs). An RDE may include a subset ID associated with the subset. The RDE may include information related to all sidelinks in a particular subset, such that the RDE may be transmitted once when a specific subset is formed. The advertisement message may indicate both the ROE and the RDE in response to a new sidelink reservation being added to the set of tracked sidelink reservations. Alternatively, the advertisement message may not indicate the RDE, in response to no new sidelink reservation being added to the set of tracked sidelink reservations. The RDE may be transmitted when a given sidelink is deleted or activated because a corresponding subset may need to be deactivated or deleted, and a new subset should be defined. The advertisement message may not indicate information related to certain sidelink reservations when the sidelink reservations are active and the information was already transmitted in a previous advertisement message. The advertisement message may be associated with sidelink reservations for which the first UE is a source or a destination, and/or the advertisement message may be associated with sidelink reservations for which the second UE is a source or a destination. The second UE may be any neighbor UE of the first UE. The first UE may advertise sidelinks in which the first UE is the source or the destination, as well as any other sidelink reservations in which any of the first UE's neighbor UEs are the source or the destination.

In some aspects, an overhead generated by the first UE may be reduced when transmitting advertisement messages to neighbor UEs, where the advertisement messages may indicate a list of tracked reservations that the first UE is tracking. The overhead may be reduced because a given sidelink may be advertised only when a corresponding subset is formed and not every time an inter-UE message is transmitted. Further, time/frequency resources used by periodic reservations in the case of Mode 2 may be controlled. As a result, an overall system performance may be improved.

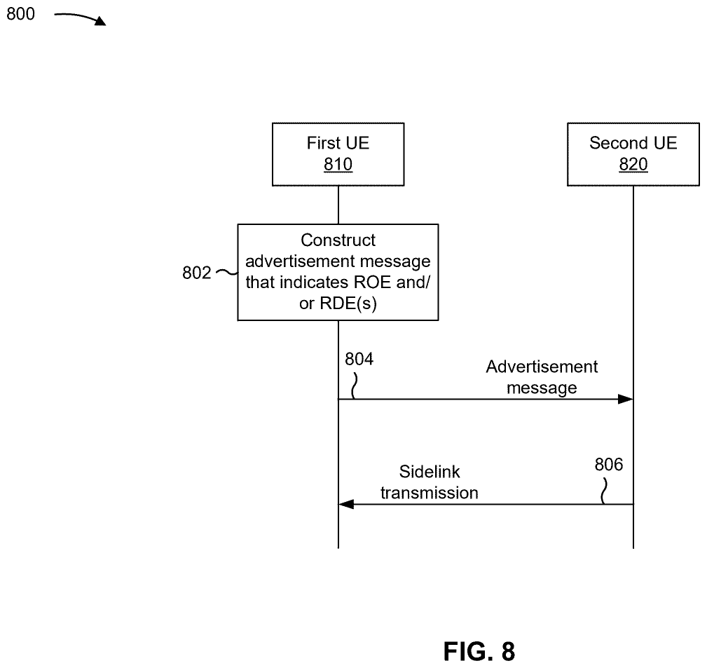

FIG. 8 is a diagram illustrating an example 800 associated with transmitting advertisement messages that indicate tracked sidelink reservations, in accordance with the present disclosure. As shown in FIG. 8, example 800 includes communication between a first UE 810 (e.g., UE 120a) and a second UE 820 (e.g., UE 120c). In some aspects, the first UE 810 and the second UE 820 may be included in a wireless network, such as wireless network 100.

As shown by reference number 802, the first UE 810 may construct an advertisement message that indicates an ROE. The ROE may include a set ID associated with a set of tracked sidelink reservations that are tracked by the first UE 810. The ROE may include a bitmap that advertises changes to a subset in the set of tracked sidelink reservations. The advertisement message may optionally indicate one or more RDEs. In some cases, the advertisement message may not indicate any RDEs. An RDE may include a subset ID associated with the subset. The RDE may include information related to all sidelinks in a particular subset, such that the RDE may be transmitted once when a specific subset is formed. At least one sidelink per subset should be present and all sidelinks in a given subset should be advertised in a given RDE. The advertisement message may indicate multiple RDEs when multiple subsets are simultaneously formed. The advertisement message may indicate both the ROE and the RDE in response to a new sidelink reservation being added to the set of tracked sidelink reservations. Alternatively, the advertisement message may not indicate the RDE, in response to no new sidelink reservation being added to the set of tracked sidelink reservations. The advertisement message may not indicate information related to certain sidelink reservations when the sidelink reservations are active, and when the information was already transmitted in a previous advertisement message and a corresponding subset is still active. The advertisement message may be associated with sidelink reservations for which the first UE 810 is a source or a destination, and/or the advertisement message may be associated with sidelink reservations for which the second UE 820 is a source or a destination. The second UE 820 may be any neighbor UE of the first UE 810. The first UE 810 may advertise sidelinks in which the first UE 810 is the source or the destination, as well as any other sidelink reservations in which any of the first UE's neighbor UEs are the source or the destination.

In some aspects, the first UE 810 may advertise sidelink reservations in accordance with certain conditions. The sidelink reservations that are advertised by the first UE 810 may be sidelink reservations in which the first UE 810 is the source or the destination, or the sidelink reservations from direct neighbor UEs of the first UE 810 in which the direct neighbor UEs are the source or the destination. A UE, such as the second UE 820, may be considered to be a direct neighbor UE of the first UE 810 when the first UE 810 has received at least one ROE within a certain time duration from the second UE 820, an RSRP measurement between the first UE 810 and the second UE 820 satisfies a threshold, the first UE 810 and the second UE 820 are in a same zone defined by a zone ID, and/or the first UE 810 and the second UE 820 are already in some form of sidelink communication. The first UE 810 may not advertise sidelink reservations for neighbor UEs that are not considered to be direct neighbors. Conventionally, the first UE 810 would receive from its neighbor UEs a list of reservations that the neighbor UEs were tracking. When forming its own inter-UE coordination message, the first UE 810 would include the sidelink reservations tracked by all of its neighbor UEs, which could be overly burdensome. Thus, a set of conditions may be defined to limit the sidelinks that the first UE 810 should advertise by only considering the inter UE messages received from some “direct” neighbor UEs that verifies a specific set of conditions. In some aspects, the first UE 810 may receive inter-UE messages from all of its neighbor UEs. However, the first UE 810 may only include, in the advertisement message, the sidelink reservations in which a neighbor UE is the source or the destination and the neighbor UE satisfies some criteria.

In some aspects, the information may indicate a reservation ID, a source ID, a destination ID, a cast type, a forwarded before or not status, an RSRP measurement, reserved resources associated with a frequency location, a bandwidth and a periodicity, a zone ID, a packet priority of a sidelink communication, an MCS, a cast type, a communication range specification, geographical zone information, a feedback utilization status of the sidelink communication, a channel busy ratio (CBR),

In some aspects, the set of tracked sidelink reservations may include sidelink reservations associated with the first UE 810 and sidelink reservations associated with certain neighbor UEs, where the neighbor UEs may include the second UE 820. Not all received sidelink reservations may be advertised by the first UE 810 but only those sidelink reservations in which the first UE 810 is the source or the destination, or only those sidelink reservations in which the neighbor UE (e.g., the second UE 820) is the source or the destination and the neighbor UE has been verified to satisfy certain conditions. In some aspects, the subset may be permitted to be created or deleted only one time for a given set, and the subset cannot be changed, updated, and/or modified by an addition or a removal of sidelink reservations. An event of subset deletion or removal may be signaled based at least in part via a value change of the corresponding bit in the bitmap. In some aspects, a length of the bitmap may correspond to a maximum number of simultaneous subsets in the set of tracked sidelink reservations. When a maximum number of subsets is attained and a formation of a new subset is needed (e.g., due to a new tracked sidelink reservation), the set ID in the ROE may be incremented and all tracked sidelink reservations may again be organized into new subsets and advertised.

In some aspects, the second UE 820 may compare the bitmap to a previous bitmap received in a previous advertisement message. The second UE 820 may determine, based at least in part on the comparison, that at least one previous advertisement message was not successfully received by the second UE 820. In some aspects, the second UE 820 may compare the bitmap to a default bitmap. The second UE 820 may transmit, to the first UE 810 and based at least in part on the comparison, a request for an advertisement message that indicates other subsets of sidelink reservations.

In some aspects, the first UE 810 may receive, from the second UE 820, a request for a missing RDE based at least in part on the advertisement message not including the RDE. The first UE 810 may transmit, to the second UE 820, a unicast transmission that indicates the missing RDE. In some aspects, the first UE 810 may retransmit or broadcast one or more RDEs in a periodic manner, where the one or more RDEs may be changed or not changed, in relation to a previous transmission of the one or more RDEs.

In some aspects, the ROE may indicate a limit on a number of sidelink reservations, a limit on an amount of sidelink reservation resources, a number of sidelink reservations associated with the set of tracked sidelink reservations, a portion of resources used by the set of tracked sidelink reservations, and/or a setting by the first UE 810. The setting may allow the second UE 820 to start a new reservation or the setting may prevent the second UE 820 from starting any new periodic reservation in case, for example, resources are already over reserved by periodic reservations. In some aspects, the ROE may indicate a limit on a number of high priority sidelink reservations, a limit on a number of low priority sidelink reservations, a limit on an amount of high priority sidelink reservation resources, and/or a limit on an amount of low priority sidelink reservation resources.

As shown by reference number 804, the first UE 810 may transmit, to the second UE 820, the advertisement message that indicates the ROE. The first UE 810 may transmit the advertisement message via a dedicated resource with a predefined periodicity, or along with a data transmission. The first UE 810 may transmit the advertisement message via a broadcast transmission or via a unicast transmission (e.g., in a first stage SCI). The first UE 810 may transmit the advertisement message in response to an event trigger. The first UE 810 may transmit the advertisement message based at least in part on an explicit request by the second UE 820.

As shown in FIG. 8, the second UE 820 may transmit, to the first UE 810 or to a third UE (not shown in FIG. 8), a sidelink transmission 806 based at least in part on the advertisement message 804. The first UE 810 may receive the sidelink transmission 806 from the second UE 820 based at least in part on the advertisement message 804. The second UE 820 may transmit the sidelink transmission 806 based at least in part on the ROE and/or the one or more RDEs. The second UE 820 may select resources for the sidelink transmission 806 that avoid resources associated with the sidelink reservations indicated in the advertisement message 804.

As indicated above, FIG. 8 is provided as an example. Other examples may differ from what is described with regard to FIG. 8.

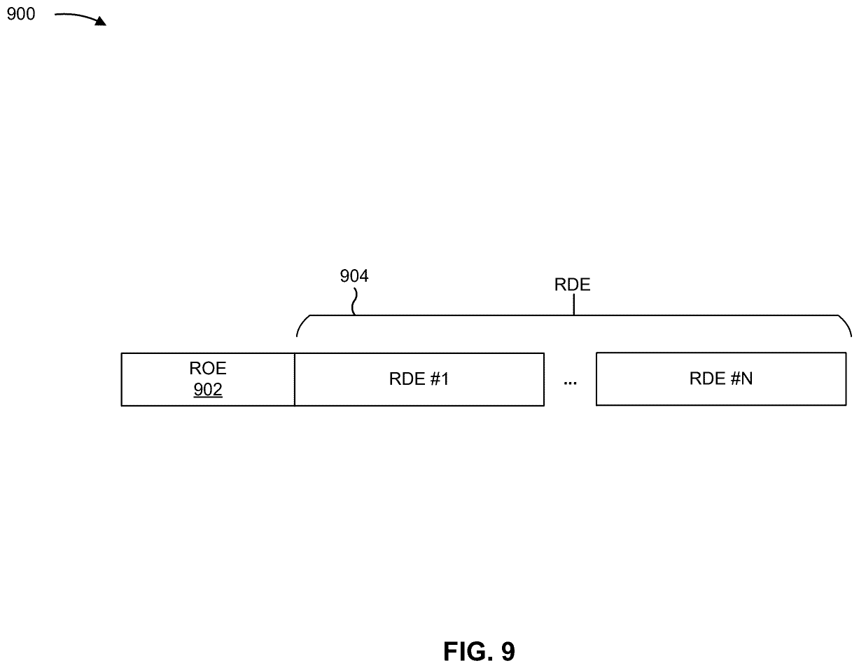

FIG. 9 is a diagram illustrating an example 900 associated with transmitting advertisement messages that indicate tracked sidelink reservations, in accordance with the present disclosure.

In some aspects, as part of a reservation advertisement procedure, a UE may notify a neighbor UE (or multiple neighbor UEs) regarding changes to the UE's set of tracked reservations. The UE may indicate changes to the set of tracked reservations, rather than transmitting a whole set (or an entire set) of tracked reservations. The UE may transmit such a notification via an advertisement message.

As shown in FIG. 9, the advertisement message may include a reservation overview element (ROE) 902. The advertisement message may optionally include one or multiple reservation detail elements (RDEs) 904. In other words, the advertisement message may always contain one ROE 902 and optionally one or more RDEs 904 (e.g., RDE #1 to RDE #N). In some cases, the advertisement message may not contain any RDEs 904 (e.g., no RDEs 904 or zero RDEs 904).

In some aspects, the UE may transmit both the ROE 902 and the RDE 904 when new reservations are added to a tracked list and need to be advertised, e.g., at t₁ (as shown in FIG. 7). When no new reservation is added, only the ROE 902 may be transmitted (e.g. at t₂). An overhead may be reduced because only the ROE 902 may be transmitted when no reservation is added, and because parameters of old reservations may not be retransmitted when not necessary. For example, while reservation₁ is still active at t₃, the UE may not transmit its parameter at t₃ because the parameter was already advertised at t₁. The UE may be able to form the ROE 902 and/or the RDE 904 at each time tᵢ, and then include the ROE 902 and/or the RDE 904 in the advertisement message.

As indicated above, FIG. 9 is provided as an example. Other examples may differ from what is described with regard to FIG. 9.

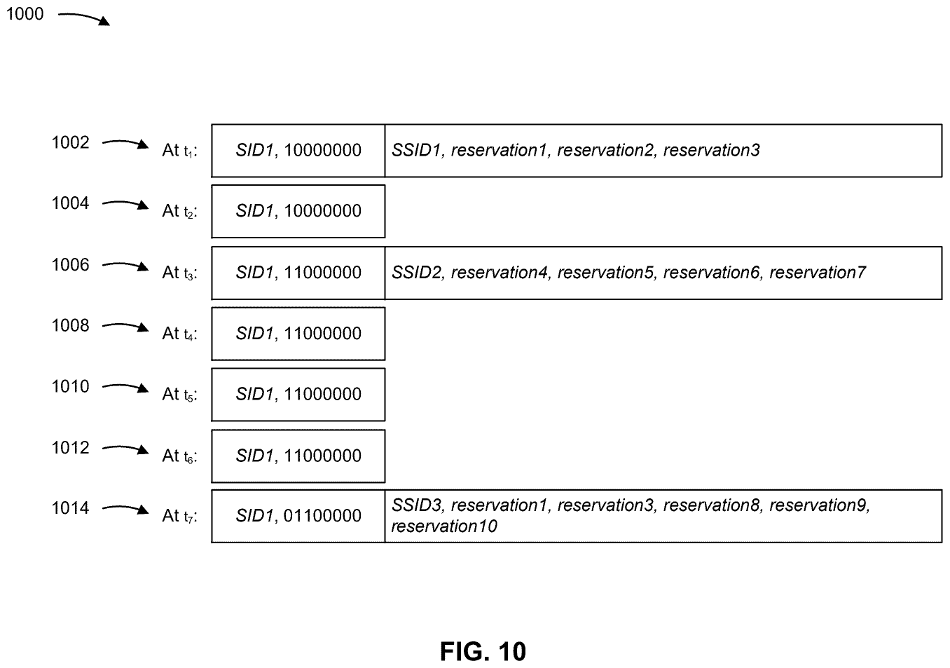

FIG. 10 is a diagram illustrating an example 1000 associated with transmitting advertisement messages that indicate tracked sidelink reservations, in accordance with the present disclosure.

In some aspects, all reservations tracked by a first UE may be grouped into a set identified by an identifier (ID) denoted by SIDᵢ where i∈{1, 2, . . . , M}. SID; may be associated with periodic reservations of the first UE, as well as reservations of the first UE's neighbor UEs, such as a second UE. A set of tracked reservations may be divided into N disjoint subsets. Each subset may be identified by an ID SSID; where i∈{1, 2, . . . , N}. Reservations may not be created at the same time, so the subsets may be formed gradually with time.

In some aspects, at t₁, SSID₁ may be constructed and associated with reservations including {reservation₁, reservation₂, reservation₃} and SID₁ may be associated with reservations including {reservation₁, reservation₂, reservation₃}. As explained further below, as no additional subset of sidelink reservations is formed between t₁ and t₂, only an ROE with the SSID₁ and the bitmap 10000000 may be transmitted at t₂. At t₃, new reservations may be tracked and SSID₂ may be constructed and associated with reservations including {reservation₄, reservation₅, reservation₆, reservation₇}. Therefore, SID₁ may contain/reservation₁, reservation₂, reservation₃, reservation₄, reservations, reservation₆, reservation₇}. At t₇, reservation₂ may be deleted or deactivated and new reservations {reservation₈, reservation₉, reservation₁₀} may be tracked. SSID₁ may be deleted and SSID₃ may be constructed and associated with reservations including {reservation₁, reservation₃, reservation₈, reservation₉, reservation₁₀}. Therefore, in this scenario, SID₁ may contain {reservation₄, reservations, reservation₆, reservation₇, reservation₁, reservation₃, reservation₈, reservation₉, reservation₁₀}. When a reservation is deleted, a corresponding subset may be deleted, and remaining active reservations may be added to a new subset.

In some aspects, an ROE may advertise changes in subsets. The ROE may track the subsets using a bitmap. In some examples, the bitmap may be initialized to 00000000 based at least in part on an assumption that a length of the bitmap is equal to 8. For example, only one subset may be formed at t₁ and the bitmap may be 10000000, where a bit corresponding to a first subset may be set from 0 to 1. At t₁, an ROE may be SID₁, 10000000 (as shown by reference number 1002). As new reservations are tracked at t₁ which were not present at t₀, an advertisement message at t₁ may contain both an ROE and an RDE. The ROE may be associated with the bitmap 10000000 and the reservation set ID SID₁. The RDE may contain an ID of a first subset SSID₁ and reservation information regarding all reservations associated with the first subset SSID₁, e.g., reservation₁, reservation₂, reservation₃. As a result, at t₁, the advertisement message may include the ROE of SID₁, 10000000 and the RDE of SSID₁, reservation₁, reservation₂, reservation₃ (as shown by reference number 1002).

In some aspects, the advertisement message may indicate periodic reservations, but the advertisement message may not necessarily be limited to periodic reservations. The reservation information indicated in an RDE may contain information that enables a receiver to determine all reserved resources in time and frequency of that specific reservation. The reservation information may include a reservation ID, a source ID, a destination ID, a cast type, an indicator associated with forwarded before or not, an RSRP measurement, reserved resources (e.g., frequency location, bandwidth, time, and/or periodicity), a zoned ID, a packet priority of a sidelink communication associated with the second UE, an MCS, a cast type, a remaining packet delay budget, a communication range specification or geographical zone (location) information, a hybrid automatic repeat request (HARQ) acknowledgment (ACK) utilization status associated with a sidelink communication, a CBR

In some aspects, when no additional subset of reservations are formed by t₂, the first UE may only transmit an ROE with the ID SID₁ and the bitmap set to 10000000. The first UE's neighbor UEs, such as the second UE, may compare the received set ID SID₁ and the bitmap set to 10000000 at t₂ with the set ID and bitmap stored at t₁, and based at least in part on the comparison, the neighbor UEs may conclude that no additional reservations are advertised by the first UE. As a result, at t₂, the advertisement message may only contain the ROE of SID₁, 10000000 (as shown by reference number 1004).

In some aspects, at t₃, a second subset may be formed. An ROE may contain SID₁ and a bitmap set to 11000000, where a bit (in the bitmap set to 11000000) corresponding to the second subset is changed from 0 to 1. An RDE may contain an ID of the second subset SSID₂ and parameters of reservation₄, reservation₅, reservation₆, reservation₇. As a result, at t₃, the advertisement message may contain the ROE of SID₁, 11000000 and an RDE of SSID₂, reservation₄, reservations, reservation₆, reservation₇ (as shown by reference number 1006).

In some aspects, no additional subsets of reservations may be formed between t₃ and t₆, so only an ROE of SID₁ and the bitmap set to 11000000 may be transmitted at t₄, t₅, and t₆ (as shown by reference numbers 1008, 1010, and 1012, respectively). A signaling overhead may be significantly reduced because reservation parameters may only be transmitted when necessary (e.g., when a reservation set actually does change). In other words, RDEs may only be transmitted occasionally, which may reduce the signaling overhead.

In some aspects, for a given reservation set ID SID₁, a subset may only be created or deleted once. The subset cannot be updated by adding or removing any reservation. The subset may be deleted by setting a corresponding bit in a bitmap from 1 to 0. For example, reservation₂ may be deactivated between t₆ and t₇. The first UE may then form a new third subset with ID SSID₃. The third subset SSID₃ may contain reservations from SSID₁ that are still active (e.g., reservation₁, reservation₃) as well as new tracked reservations (e.g., reservation₈, reservation₉, reservation₁₀). The first UE may also inform all neighbor UEs that the first subset SSID₁ was deleted by setting its bit in the bitmap from 1 to 0. An ROE may contain SID₁ and 01100000. An RDE may contain SSID₃ and parameters of reservation₁, reservation₃, reservation₈, reservation₉, reservation₁₀. As a result, at t₇, the advertisement message may contain the ROE of SID₁, 01100000 and an RDE of SSID₃, reservation₁, reservation₃, reservation₈, reservation₉, reservation₁₀ (as shown by reference number 1014).

In some aspects, a length of a bitmap (e.g., 8 bits) may correspond to a maximum number of subsets N in a set. For a given reservation set ID SID₁, when N subsets were formed and a new subset is needed to be formed (e.g., a new reservation to track or an existing reservation was deactivated), the set ID may be incremented by 1 (e.g., SID₂=(SID₁+1) mod M) and the new subsets may be formed, where M denotes a predefined integer (e.g., M=256). Multiple RDEs may be transmitted simultaneously when multiple subsets are formed at the same time. Each RDE may be identified by an ID SSIDᵢ of a corresponding subset i. The reservation advertisement message may be transmitted using a dedicated resource with a predefined periodicity, or the reservation advertisement message may be transmitted with a data transmission. For example, an ROE may be transmitted in a second stage SCI, and RDEs (if any) may be transmitted in a MAC-CE. A periodicity of sharing such information may be dictated by a data reservation periodicity.

As indicated above, FIG. 10 is provided as an example. Other examples may differ from what is described with regard to FIG. 10.

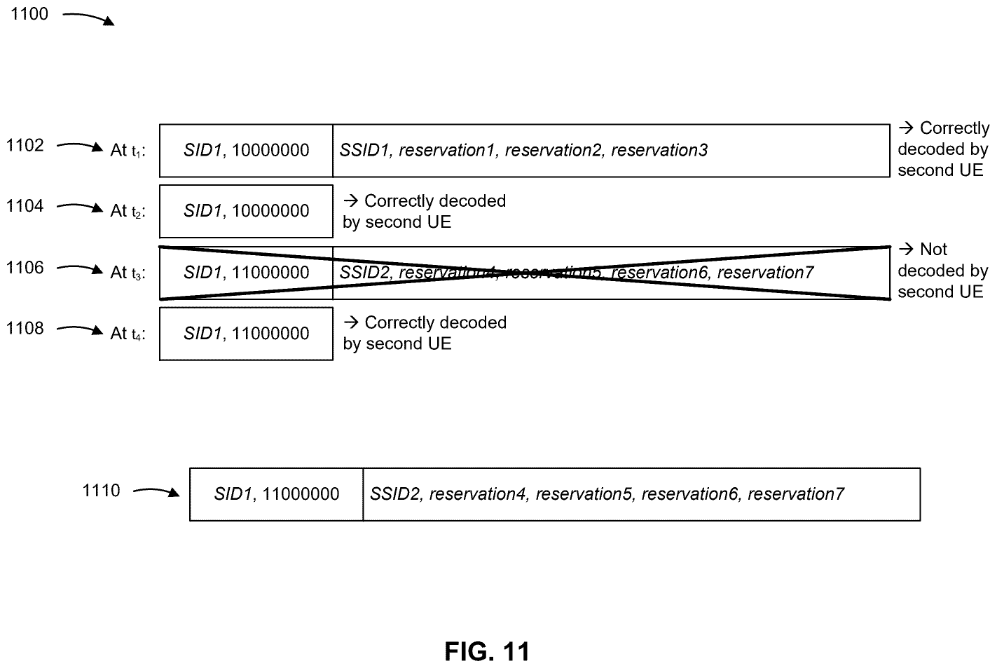

FIG. 11 is a diagram illustrating an example 1100 associated with transmitting advertisement messages that indicate tracked sidelink reservations, in accordance with the present disclosure.

In some aspects, a first UE may be tracking reservations over a period of time (e.g., as shown in FIG. 10). A neighbor UE, such as a second UE, may only receive some (but not all) advertisement messages from the first UE. The second UE may receive and correctly decode, at t₁, an advertisement message that contains an ROE of SID₁, 10000000 and an RDE of SSID₁, reservation₁, reservation₂, reservation₃ (as shown by reference number 1102). The second UE may receive and correctly decode, at t₂, an advertisement message that contains an ROE of SID₁, 10000000 (as shown by reference number 1104). The second UE may not successfully receive, at t₃, an advertisement message that contains an ROE of SID₁, 11000000 and an RDE of SSID₂, reservation₄, reservations, reservation₆, reservation₇ (as shown by reference number 1106). The second UE may receive and correctly decode, at t₄, an advertisement message that contains an ROE of SID₁, 11000000 (as shown by reference number 1108). The second UE may compare the bitmap 11000000 received at t₄ with the bitmap 10000000 received at t₂, and based at least in part on the comparison, the second UE may determine that an RDE corresponding to a second subset SSID₂ was not received.

In some aspects, the second UE may transmit, to the first UE, an RDE request message, in which the second UE may request for a retransmission of a missing RDE (e.g., SSID₂). The first UE may transmit, to the second UE and via a unicast transmission, an advertisement message that indicates the missing RDE (e.g., RDE ((SSID₂, reservation₄, reservations, reservation₆, reservation₇)) (as shown by reference number 1110). An ability to request missing RDEs may be useful when a new neighbor UE detects only a latest message advertisement, which may occur when the new neighbor UE was just turned on.

In some aspects, the first UE may periodically retransmit or broadcast RDEs, even when reservation sets and subsets do not change. One bit may be added to an ROE to indicate whether a corresponding RDE is a new RDE or a retransmitted RDE. Such an added bit may allow neighbor UEs to bypass a decoding of the retransmitted RDEs when such retransmitted RDEs are not needed by the neighbor UEs. An ability to receive retransmitted or broadcast RDEs may be useful when the new neighbor UE detects only the latest message advertisement, which may occur when the new neighbor UE was just turned on.

As indicated above, FIG. 11 is provided as an example. Other examples may differ from what is described with regard to FIG. 11.

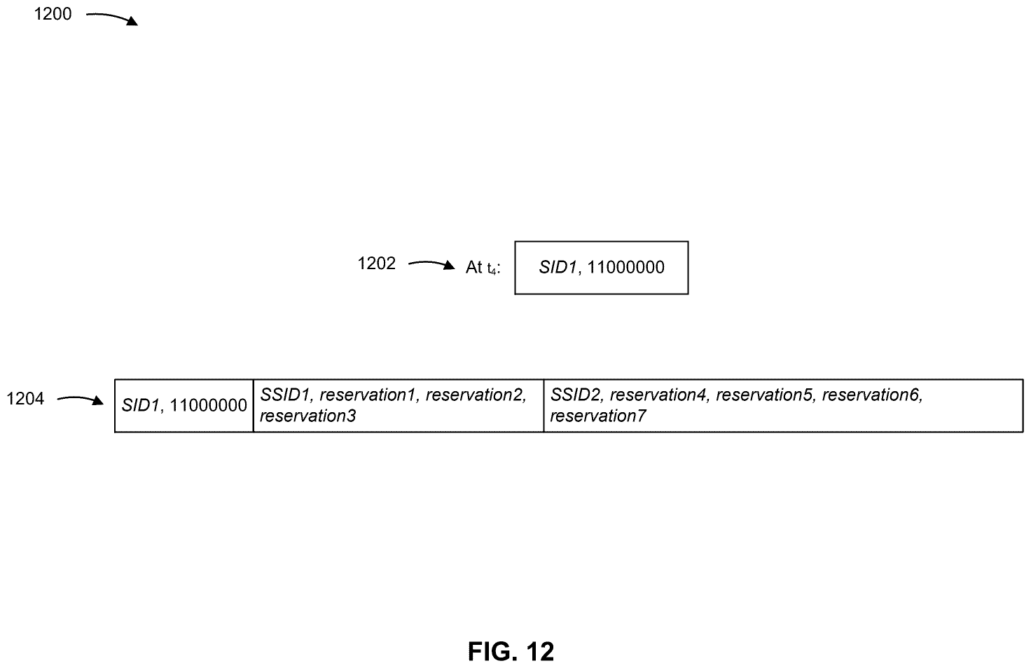

FIG. 12 is a diagram illustrating an example 1200 associated with transmitting advertisement messages that indicate tracked sidelink reservations, in accordance with the present disclosure.

In some aspects, a second UE may turn on at time t, where t₃<t<t₄. At t₄, the second UE may receive, from a first UE, an advertisement message that contains an ROE of SID₁, 11000000 (as shown by reference number 1202). Since the second UE just turned on, the second UE may compare the received bitmap 11000000 with a default bitmap of 00000000. The second UE may request the first UE to transmit reservations corresponding to first and second subsets. The first UE may respond by transmitting, to the second UE, an advertisement message that contains an ROE of SID₁, 11000000, a first RDE of SSID₁, reservation₁, reservation₂, reservation₃, and a second RDE of SSID₂, reservation₄, reservations, reservation₆, reservation₇ (as shown by reference number 1204).

As indicated above, FIG. 12 is provided as an example. Other examples may differ from what is described with regard to FIG. 12.

In some aspects, a first UE may only advertise reservations in which the first UE is a source or a destination, or the UE may only advertise reservations from a direct neighbor UE in which the neighbor UE is a source or a destination. A second UE may be considered to be the direct neighbor UE of the first UE when the first UE has received at least one ROE in a last advertisement_time_limit seconds from the second UE, an RSRP between the second UE and the first UE is larger than an advertisement_RSRP_limit, the first UE and the second UE are in a same zone defined by a zone ID, and/or the first UE and the second UE are in some sidelink communication already (e.g., unicast, broadcast, or groupcast). By requiring the first UE to have received at least one ROE in the last advertisement_time_limit seconds from the second UE, the first UE may not share or track unnecessary reservations due to mobility of the second UE. When a distance between the second UE and the first UE exceeds a threshold, the first UE may not be able to receive any ROE from the second UE. By requiring that the RSRP between the second UE and the first UE be larger than the advertisement_RSRP_limit, only reservations which may cause interference to the first UE may be tracked, and not all reservations may necessarily be tracked. Restricting types of reservations that are forwarded may control a repetitive forwarding of reservations. Further, in this case, a “forwarded before or not” parameter may not need to be added to a description of a reservation.

In some aspects, a number of reservations that the first UE is able to track may be limited due to memory and/or processing limitations, and such a limit may be referred to as reservations_number_limit. A portion (or percentile) of time and frequency resources that may be allowed to be allocated to periodic reservations may be limited, and such a limit may be referred to as reservations_resources_limit. The reservations_resources_limit may be computed relative to a predefined window (e.g., 1000 ms) and may permit keeping a portion of resources to sidelink non-periodic communications. For example, when the reservations_resources_limit is set to 75%, only 75% of resources may be used by periodic reservations and 25% of resources should be used for ad-hoc non-periodic transmissions. For high priority periodic reservations, the reservations_resources_limit may be ignored. In this case, the reservations_resources_limit may limit resources that are useable for periodic low priority transmissions. The reservations_resources_limit may be a limit on a combination of both a CBR and a channel occupancy ratio (CR). The reservations_resources_limit may define a limit on a portion of subchannels which are reserved by direct neighbors (e.g., active neighbor UEs with, for example, RSRP values larger than a given threshold) and reserved by the first UE itself to transmit or receive data. The first UE may compute the reservations_resources_limit using a reservation set.

In some aspects, reservations_number and reservations_resource may denote a number of reservations and a portion (or percentile) of resources used by tracked reservations. The reservations_resources and reservations_number may only include advertisable reservations (e.g., reservations in which the first UE is the source or the destination, or the reservations from the direct neighbor UEs in which the direct neighbor UEs are the source or the destination).

In some aspects, the first UE may transmit an ROE that contains various elements, such as the reservations_number, the reservations_resources, the reservations_number_limit, the reservations_resources_limit, and a one bit reservations_new_accept that indicates whether the first UE allows its direct neighbors to start new periodic reservations or not. The reservations_number_limit and the reservations_resources_limit may not be indicated in the ROE when already exchanged between the first UE and the second UE (e.g., an exchange may have occurred when a link/session between the UEs was initialized/created). At the first UE, reservations_new_accept=1 when reservations_resources<reservations_{resources}_{ₗᵢₘᵢₜ}, all direct neighbor UEs have reservations_new_accept=1, and reservations_number<reservations_resources_limit. As a result, a direct neighbor UE of the first UE may be prohibited to initialize any new reservation when the direct neighbor UE receives reservations_new_accept=0 from the first UE, or a new reservation may make, at the first UE, reservations_resources>reservations_resources_limit or reservations_number>reservations_number_limit.

In some aspects, two sets of limits may be defined in order to separate high priority reservations and low priority reservations. In this case, four limits may be defined: reservations_hp_number_limit (representing a limit of a number of high priority reservations), reservations_nhp_number_limit (representing a limit of a number of non-high priority reservations), reservations_hp_resources_limit (representing a limit of resources for high priority reservations), and reservations_nhp_resources_limit (representing a limit of resources for non-high priority reservations). In some aspects, the first UE may transmit an ROE, where the ROE may contain the reservations_nhp_number, the reservations_nhp_resources, the reservations_nhp_number_limit, the reservations_nhp_resources_limit, the reservations_hp_number, the reservations_hp_resources, the reservations_hp_number_limit, the reservations_hp_resources_limit, and the one bit reservations_new_accept that indicates whether the first UE allows its direct neighbor UEs to start new periodic reservations or not. Such limits, such as the reservations_nhp_number_limit, the reservations_nhp_resources_limit, the reservations_hp_number_limit, and/or the reservations_hp_resources_limit may not be included in the ROE when already exchanged between the first UE and the second UE (e.g., the exchange may have occurred when the link/session between the UEs was initialized/created).

In some aspects, a direct neighbor UE of the first UE may not initialize any new reservation when the direct neighbor UE receives reservations_new_accept=0 from the first UE, or the new reservation may not be initialized when causing, at the first UE, reservations_nhp_resources>reservations_nhp_resources_limit, reservations_nhp_number>reservations_nhp_number_limit, reservations_hp_resources>reservations_hp_resources_limit, or reservations_hp_number>reservations_hp_number_limit.

FIG. 13 is a diagram illustrating an example process 1300 performed, for example, at a first UE or an apparatus of a first UE, in accordance with the present disclosure. Example process 1300 is an example where the apparatus or the first UE (e.g., UE 120a) performs operations associated with transmitting advertisement messages that indicate tracked sidelink reservations.

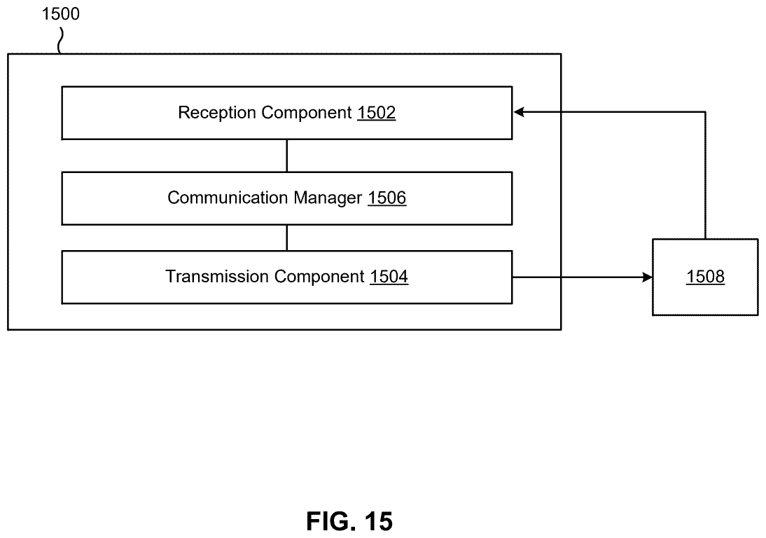

As further shown in FIG. 13, in some aspects, process 1300 may include generating a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations (block 1310). For example, the first UE (e.g., using communication manager 1506, depicted in FIG. 15) may generate a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations, as described above.

As shown in FIG. 13, in some aspects, process 1300 may include transmitting the message to a second UE (block 1320). For example, the first UE (e.g., using transmission component 1504, and/or communication manager 1506, depicted in FIG. 15) may transmit the message to a second UE, as described above.

Process 1300 may include additional aspects, such as any single aspect or any combination of aspects described below and/or in connection with one or more other processes described elsewhere herein.

In a first aspect, the message further includes information indicating an addition of at least one new sidelink resource reservation to the subset or a removal of an existing sidelink resource reservation from the subset.

In a second aspect, alone or in combination with the first aspect, the message excludes information indicating an addition of at least one new sidelink resource reservation to the subset based on whether a previous message transmitted to the second UE included the information indicating the addition of the at least one new sidelink resource reservation to the subset.

In a third aspect, alone or in combination with one or more of the first and second aspects, the message excludes the information indicating the addition of the at least one new sidelink resource reservation to the subset further based on whether the at least one new sidelink resource reservation is active.

In a fourth aspect, alone or in combination with one or more of the first through third aspects, the information indicating the addition of the at least one new sidelink resource reservation to the subset or the removal of the existing sidelink resource reservation from the subset indicates one or more of a reservation ID, a source ID, a destination ID, a cast type, a forwarded before or not status, an RSRP measurement, reserved resources associated with a frequency location, a bandwidth and a periodicity, a zone ID, a packet priority of a sidelink, an MCS, a cast type, a communication range specification, geographical zone information, a feedback utilization status of the sidelink communication, a CBR,

In a fifth aspect, alone or in combination with one or more of the first through fourth aspects, the information that indicates the change to the subset of the set of sidelink resource reservations includes a bitmap in a ROE field, and wherein the information indicating the addition of the at least one new sidelink resource reservation to the subset or the removal of the existing sidelink resource reservation from the subset is included in one of multiple RDE fields when multiple subsets of the set of sidelink resource reservations are concurrently advertised.

In a sixth aspect, alone or in combination with one or more of the first through fifth aspects, the set of sidelink reservations includes sidelink reservations associated with the first UE and sidelink reservations associated with neighbor UEs that satisfy criteria, wherein the neighbor UEs include the second UE.

In a seventh aspect, alone or in combination with one or more of the first through sixth aspects, the subset is permitted to be created or deleted only one time for a given set, and the subset cannot be changed, updated, or modified by an addition or a removal of sidelink reservations, and an event of subset deletion or removal is signaled based at least in part via a value change of the corresponding bit in a bitmap.

In an eighth aspect, alone or in combination with one or more of the first through seventh aspects, a length of the bitmap corresponds to a maximum number of subsets in the set of sidelink reservations, and wherein the set ID in the resource reservation information is incremented based at least in part on a maximum number of subsets being attained and a formation of a new subset being needed due to an addition of at least one new tracked sidelink reservation or a removal or deactivation of at least one existing sidelink reservation.

In a ninth aspect, alone or in combination with one or more of the first through eighth aspects, the message is transmitted via a dedicated resource with a predefined periodicity, the message is transmitted along with a data transmission, the message is event triggered, or the message is in response to an explicit request by the second UE.

In a tenth aspect, alone or in combination with one or more of the first through ninth aspects, process 1300 includes receiving, from the second UE, a request for missing information based at least in part on the message not including the information (e.g., an RDE) indicating the addition of at least one new sidelink resource reservation to the subset or the removal of the existing sidelink resource reservation from the subset, and transmitting, to the second UE, a unicast transmission that indicates the missing information.

In an eleventh aspect, alone or in combination with one or more of the first through tenth aspects, process 1300 includes retransmitting or broadcasting, in a periodic manner, information indicating an addition of at least one new sidelink resource reservation to the subset or a removal of an existing sidelink resource reservation from the subset.

In a twelfth aspect, alone or in combination with one or more of the first through eleventh aspects, the message indicates sidelink reservations for which the first UE is a source or a destination, or the message indicates sidelink reservations for which the second UE is a source or a destination and criteria is satisfied.

In a thirteenth aspect, alone or in combination with one or more of the first through twelfth aspects, the criteria is satisfied when the first UE has received at least one resource reservation information within a certain time duration from the second UE, an RSRP measurement between the first UE and the second UE satisfies a threshold, the first UE and the second UE are in a same zone defined by a zone ID, or the first UE and the second UE are already in some form of sidelink communication.

In a fourteenth aspect, alone or in combination with one or more of the first through thirteenth aspects, the resource reservation information indicates one or more of a limit on a number of sidelink reservations, a limit on an amount of sidelink reservation resources, a number of sidelink reservations associated with the set of sidelink reservations, a portion of resources used by the set of sidelink reservations, or a setting by the first UE that allows the second UE to determine whether to start or not start new periodic reservations.

In a fifteenth aspect, alone or in combination with one or more of the first through fourteenth aspects, the resource reservation information indicates one or more of a limit on a number of high priority sidelink reservations, a limit on a number of low priority sidelink reservations, a limit on an amount of high priority sidelink reservation resources, or a limit on an amount of low priority sidelink reservation resources.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a second UE or an apparatus of a second UE, in accordance with the present disclosure. Example process 1400 is an example where the apparatus or the second UE (e.g., UE 120c) performs operations associated with transmitting advertisement messages that indicate tracked sidelink reservations.

As shown in FIG. 14, in some aspects, process 1400 may include receiving, from a first UE, a message that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations (block 1410). For example, the second UE (e.g., using reception component 1502 and/or communication manager 1506, depicted in FIG. 15) may receive, from a first UE, a message that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations, as described above.

As further shown in FIG. 14, in some aspects, process 1400 may include transmitting, to the first UE or to a third UE, a sidelink transmission based at least in part on the message (block 1420). For example, the second UE (e.g., using transmission component 1504 and/or communication manager 1506, depicted in FIG. 15) may transmit, to the first UE or to a third UE, a sidelink transmission based at least in part on the message, as described above.

Process 1400 may include additional aspects, such as any single aspect or any combination of aspects described below and/or in connection with one or more other processes described elsewhere herein.

In a first aspect, the message further includes information indicating an addition of at least one new sidelink resource reservation to the subset or a removal of an existing sidelink resource reservation from the subset.

In a second aspect, alone or in combination with the first aspect, the message excludes information indicating an addition of at least one new sidelink resource reservation to the subset based on whether a previous message transmitted to the second UE included the information indicating the addition of the at least one new sidelink resource reservation to the subset.

In a third aspect, alone or in combination with one or more of the first and second aspects, the message excludes the information indicating the addition of the at least one new sidelink resource reservation to the subset further based on whether the at least one new sidelink resource reservation is active.

In a fourth aspect, alone or in combination with one or more of the first through third aspects, the information indicating the addition of the at least one new sidelink resource reservation to the subset or the removal of the existing sidelink resource reservation from the subset indicates one or more of a reservation ID, a source ID, a destination ID, a cast type, a forwarded before or not status, an RSRP measurement, reserved resources associated with a frequency location, a bandwidth and a periodicity, a zone ID, a packet priority of a sidelink communication, an MCS, a cast type, a communication range specification, geographical zone information, a feedback utilization status of the sidelink communication, and/or a CBR.

In a fifth aspect, alone or in combination with one or more of the first through fourth aspects, the information that indicates the change to the subset of the set of sidelink resource reservations includes a bitmap in a ROE field, and wherein the information indicating the addition of the at least one new sidelink resource reservation to the subset or the removal of the existing sidelink resource reservation from the subset is included in one of multiple RDE fields when multiple subsets of the set of sidelink resource reservations are concurrently advertised.

In a sixth aspect, alone or in combination with one or more of the first through fifth aspects, the set of sidelink reservations include sidelink reservations associated with the first UE and sidelink reservations associated with neighbor UEs that satisfy criteria, wherein the neighbor UEs include the second UE.

In a seventh aspect, alone or in combination with one or more of the first through sixth aspects, the subset is permitted to be created or deleted only one time for a given set, and the subset cannot be changed, updated, and/or modified by an addition or a removal of sidelink reservations, and an event of subset deletion or removal is signaled based at least in part via a value change of the corresponding bit in a bitmap.

In an eighth aspect, alone or in combination with one or more of the first through seventh aspects, a length of the bitmap corresponds to a maximum number of subsets in the set of sidelink reservations, and wherein the set ID in the resource reservation information is incremented based at least in part on a maximum number of subsets being attained and a formation of a new subset being needed due to a new tracked sidelink reservation.

In a ninth aspect, alone or in combination with one or more of the first through eighth aspects, the message is received via a dedicated resource with a predefined periodicity, the message is received along with a data transmission, the message is event triggered, or the message is in response to an explicit request by the second UE.

In a tenth aspect, alone or in combination with one or more of the first through ninth aspects, process 1400 includes comparing the information that indicates the change to previous information received in a previous message, and determining, based at least in part on the comparing, that at least one previous message was not successfully received by the second UE.

In an eleventh aspect, alone or in combination with one or more of the first through tenth aspects, process 1400 includes transmitting, to the first UE, a request for missing information based at least in part on the message not including the information indicating the addition of at least one new sidelink resource reservation to the subset or the removal of the existing sidelink resource reservation from the subset, and receiving, from the first UE, a unicast transmission that indicates the missing information.

In a twelfth aspect, alone or in combination with one or more of the first through eleventh aspects, process 1400 includes receiving, from the first UE and in a periodic manner, a retransmission or a broadcast of information indicating an addition of at least one new sidelink resource reservation to the subset or a removal of an existing sidelink resource reservation from the subset.

In a thirteenth aspect, alone or in combination with one or more of the first through twelfth aspects, process 1400 includes comparing the information that indicates the change to default information, and transmitting, to the first UE and based at least in part on the comparing, a request for a message that indicates other subsets of sidelink reservations.

In a fourteenth aspect, alone or in combination with one or more of the first through thirteenth aspects, the message indicates sidelink reservations for which the first UE is a source or a destination, or the advertisement message indicates sidelink reservations for which the second UE is a source or a destination and criteria is satisfied.

In a fifteenth aspect, alone or in combination with one or more of the first through fourteenth aspects, the criteria is satisfied when the first UE has received at least one resource reservation information within a certain time duration from the second UE, an RSRP measurement between the first UE and the second UE satisfies a threshold, the first UE and the second UE are in a same zone defined by a zone ID, or the first UE and the second UE are already in some form of sidelink communication.

In a sixteenth aspect, alone or in combination with one or more of the first through fifteenth aspects, the resource reservation information indicates one or more of a limit on a number of sidelink reservations, a limit on an amount of sidelink reservation resources, a number of sidelink reservations associated with the set of sidelink reservations, a portion of resources used by the set of sidelink reservations, or a setting by the first UE that allows the second UE to determine whether to start or not start new periodic reservations.

In a seventeenth aspect, alone or in combination with one or more of the first through sixteenth aspects, the resource reservation information indicates one or more of a limit on a number of high priority sidelink reservations, a limit on a number of low priority sidelink reservations, a limit on an amount of high priority sidelink reservation resources, or a limit on an amount of low priority sidelink reservation resources.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a first UE, or a first UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 8-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the first UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the first UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the first UE described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The communication manager 1506 may generate a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations. The transmission component 1504 may transmit the message to a second UE.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

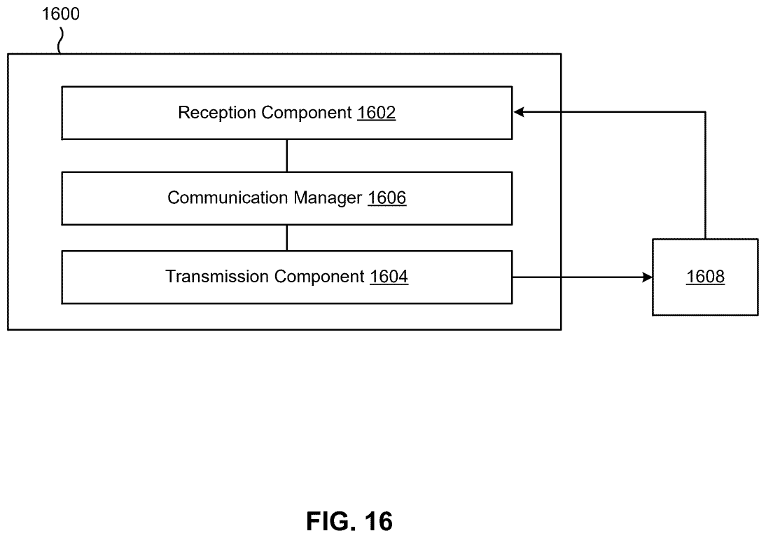

FIG. 16 is a diagram of an example apparatus 1600 for wireless communication, in accordance with the present disclosure. The apparatus 1600 may be a second UE, or a second UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 8-12. Additionally, or alternatively, the apparatus 1600 may be configured to perform one or more processes described herein, such as process 1400 of FIG. 14, or a combination thereof. In some aspects, the apparatus 1600 and/or one or more components shown in FIG. 16 may include one or more components of the second UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the second UE described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the second UE described in connection with FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive, from a first UE, a message that indicates sidelink resource reservation information, wherein the sidelink resource reservation information includes a set ID associated with a set of sidelink resource reservations that are tracked by the first UE, and wherein the resource reservation information further includes information that indicates a change to a subset of the set of sidelink resource reservations. The transmission component 1604 may transmit, to the first UE or to a third UE, a sidelink transmission based at least in part on the message.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a first user equipment (UE), comprising: generating a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and transmitting the message to a second UE.

Aspect 2: The method of Aspect 1, wherein the message further includes information indicating an addition of at least one new sidelink resource reservation to the subset or a removal of an existing sidelink resource reservation from the subset.

Aspect 3: The method of Aspect 2, wherein the message excludes information indicating an addition of at least one new sidelink resource reservation to the subset based on whether a previous message transmitted to the second UE included the information indicating the addition of the at least one new sidelink resource reservation to the subset.

Aspect 4: The method of Aspect 2, wherein the message excludes the information indicating the addition of the at least one new sidelink resource reservation to the subset further based on whether the at least one new sidelink resource reservation is active.

Aspect 5: The method of Aspect 2, wherein the information indicating the addition of the at least one new sidelink resource reservation to the subset or the removal of the existing sidelink resource reservation from the subset indicates one or more of: a reservation ID, a source ID, a destination ID, a cast type, a forwarded before or not status, a reference signal received power (RSRP) measurement, reserved resources associated with a frequency location, a bandwidth and a periodicity, a zone ID, a packet priority of a sidelink communication, a modulation and coding scheme (MCS), a cast type, a communication range specification, geographical zone information, a feedback utilization status of the sidelink communication, and/or a channel busy ratio (CBR).

Aspect 6: The method of Aspect 2, wherein the information that indicates the change to the subset of the set of sidelink resource reservations includes a bitmap in a reservation overview element (ROE) field, and wherein the information indicating the addition of the at least one new sidelink resource reservation to the subset or the removal of the existing sidelink resource reservation from the subset is included in one of multiple reservation detail element (RDE) fields when multiple subsets of the set of sidelink resource reservations are concurrently advertised.

Aspect 7: The method of any of Aspects 1-6, wherein the set of sidelink reservations include sidelink reservations associated with the first UE and sidelink reservations associated with neighbor UEs that satisfy criteria, wherein the neighbor UEs include the second UE.

Aspect 8: The method of any of Aspects 1-7, wherein the subset is permitted to be created or deleted only one time for a given set, and the subset cannot be changed, updated, or modified by an addition or a removal of sidelink reservations, and an event of subset deletion or removal is signaled based at least in part via a value change of the corresponding bit in a bitmap.

Aspect 9: The method of any of Aspects 1-8, wherein a length of the bitmap corresponds to a maximum number of subsets in the set of sidelink reservations, and wherein the set ID in the resource reservation information is incremented based at least in part on a maximum number of subsets being attained and a formation of a new subset being needed due to an addition of at least one new tracked sidelink reservation or a removal or deactivation of at least one existing sidelink reservation.

Aspect 10: The method of any of Aspects 1-9, wherein the message is transmitted via a dedicated resource with a predefined periodicity, the message is transmitted along with a data transmission, the message is event triggered, or the message is in response to an explicit request by the second UE.

Aspect 11: The method of any of Aspects 1-10, further comprising: receiving, from the second UE, a request for missing information based at least in part on the message not including the information indicating the addition of at least one new sidelink resource reservation to the subset or the removal of the existing sidelink resource reservation from the subset, and transmitting, to the second UE, a unicast transmission that indicates the missing information.

Aspect 12: The method of any of Aspects 1-11, further comprising: retransmitting or broadcasting, in a periodic manner, information indicating an addition of at least one new sidelink resource reservation to the subset or a removal of an existing sidelink resource reservation from the subset.

Aspect 13: The method of any of Aspects 1-12, wherein the message indicates sidelink reservations for which the first UE is a source or a destination, or the message indicates sidelink reservations for which the second UE is a source or a destination and criteria is satisfied.

Aspect 14: The method of Aspect 13, wherein the criteria is satisfied when the first UE has received at least one resource reservation information within a certain time duration from the second UE, a reference signal received power (RSRP) measurement between the first UE and the second UE satisfies a threshold, the first UE and the second UE are in a same zone defined by a zone ID, or the first UE and the second UE are already in some form of sidelink communication.

Aspect 15: The method of any of Aspects 1-14, wherein the one resource reservation information indicates one or more of: a limit on a number of sidelink reservations, a limit on an amount of sidelink reservation resources, a number of sidelink reservations associated with the set of sidelink reservations, a portion of resources used by the set of sidelink reservations, or a setting by the first UE that allows the second UE to determine whether to start or not start new periodic reservations.

Aspect 16: The method of any of Aspects 1-15, wherein the one resource reservation information indicates one or more of: a limit on a number of high priority sidelink reservations, a limit on a number of low priority sidelink reservations, a limit on an amount of high priority sidelink reservation resources, or a limit on an amount of low priority sidelink reservation resources.

Aspect 17: A method of wireless communication performed by a second user equipment (UE), comprising: receiving, from a first UE, a message that indicates sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and transmitting, to the first UE or to a third UE, a sidelink transmission based at least in part on the message.

Aspect 18: The method of Aspect 17, wherein the message further includes information indicating an addition of at least one new sidelink resource reservation to the subset or a removal of an existing sidelink resource reservation from the subset.

Aspect 19: The method of Aspect 18, wherein the message excludes information indicating an addition of at least one new sidelink resource reservation to the subset based on whether a previous message transmitted to the second UE included the information indicating the addition of the at least one new sidelink resource reservation to the subset.

Aspect 20: The method of Aspect 18, wherein the message excludes the information indicating the addition of the at least one new sidelink resource reservation to the subset further based on whether the at least one new sidelink resource reservation is active.

Aspect 21: The method of Aspect 18, wherein the information indicating the addition of the at least one new sidelink resource reservation to the subset or the removal of the existing sidelink resource reservation from the subset indicates one or more of: a reservation ID, a source ID, a destination ID, a cast type, a forwarded before or not status, a reference signal received power (RSRP) measurement, reserved resources associated with a frequency location, a bandwidth and a periodicity, a zone ID, a packet priority of a sidelink communication, a modulation and coding scheme (MCS), a cast type, a communication range specification, geographical zone information, a feedback utilization status of the sidelink communication, and/or a channel busy ratio (CBR).

Aspect 22: The method of Aspect 18, wherein the information that indicates the change to the subset of the set of sidelink resource reservations includes a bitmap in a ROE field, and wherein the information indicating the addition of the at least one new sidelink resource reservation to the subset or the removal of the existing sidelink resource reservation from the subset is included in one of multiple RDE fields when multiple subsets of the set of sidelink resource reservations are concurrently advertised.

Aspect 23: The method of any of Aspects 17-22, wherein the set of sidelink reservations include sidelink reservations associated with the first UE and sidelink reservations associated with neighbor UEs that satisfy criteria, wherein the neighbor UEs include the second UE.

Aspect 24: The method of any of Aspects 17-23, wherein the subset is permitted to be created or deleted only one time for a given set, and the subset cannot be changed, updated, or modified by an addition or a removal of sidelink reservations, and an event of subset deletion or removal is signaled based at least in part via a value change of the corresponding bit in a bitmap.

Aspect 25: The method of Aspect 24, wherein a length of the bitmap corresponds to a maximum number of subsets in the set of sidelink reservations, and wherein the set ID in the resource reservation information is incremented based at least in part on a maximum number of subsets being attained and a formation of a new subset being needed due to a new tracked sidelink reservation.

Aspect 26: The method of any of Aspects 17-25, wherein the message is received via a dedicated resource with a predefined periodicity, the message is received along with a data transmission, the message is event triggered, or the message is in response to an explicit request by the second UE.

Aspect 27: The method of any of Aspects 17-26, further comprising: comparing the information that indicates the change to previous information received in a previous message, and determining, based at least in part on the comparing, that at least one previous message was not successfully received by the second UE.

Aspect 28: The method of any of Aspects 17-27, further comprising: transmitting, to the first UE, a request for missing information based at least in part on the message not including the information indicating the addition of at least one new sidelink resource reservation to the subset or the removal of the existing sidelink resource reservation from the subset, and receiving, from the first UE, a unicast transmission that indicates the missing information.

Aspect 29: The method of any of Aspects 17-28, further comprising: receiving, from the first UE and in a periodic manner, a retransmission or a broadcast of information indicating an addition of at least one new sidelink resource reservation to the subset or a removal of an existing sidelink resource reservation from the subset.

Aspect 30: The method of any of Aspects 17-29, further comprising: comparing the information that indicates the change to default information, and transmitting, to the first UE and based at least in part on the comparing, a request for a message that indicates other subsets of sidelink reservations.

Aspect 31: The method of any of Aspects 17-30, wherein the message indicates sidelink reservations for which the first UE is a source or a destination, or the advertisement message indicates sidelink reservations for which the second UE is a source or a destination and criteria is satisfied.

Aspect 32: The method of Aspect 31, wherein the criteria is satisfied when the first UE has received at least one resource reservation information within a certain time duration from the second UE, a reference signal received power (RSRP) measurement between the first UE and the second UE satisfies a threshold, the first UE and the second UE are in a same zone defined by a zone ID, or the first UE and the second UE are already in some form of sidelink communication.

Aspect 33: The method of any of Aspects 17-32, wherein the resource reservation information indicates one or more of: a limit on a number of sidelink reservations, a limit on an amount of sidelink reservation resources, a number of sidelink reservations associated with the set of sidelink reservations, a portion of resources used by the set of sidelink reservations, or a setting by the first UE that allows the second UE to determine whether to start or not start new periodic reservations.

Aspect 34: The method of any of Aspects 17-33, wherein the resource reservation information indicates one or more of: a limit on a number of high priority sidelink reservations, a limit on a number of low priority sidelink reservations, a limit on an amount of high priority sidelink reservation resources, or a limit on an amount of low priority sidelink reservation resources.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 36: An apparatus for wireless communication at a device, the apparatus comprising one or more memories and one or more processors coupled to the one or more memories, the one or more processors configured to cause the device to perform the method of one or more of Aspects 1-16.

Aspect 37: An apparatus for wireless communication, the apparatus comprising at least one means for performing the method of one or more of Aspects 1-16.

Aspect 38: A non-transitory computer-readable medium storing code for wireless communication, the code comprising instructions executable by one or more processors to perform the method of one or more of Aspects 1-16.

Aspect 39: A non-transitory computer-readable medium storing a set of instructions for wireless communication, the set of instructions comprising one or more instructions that, when executed by one or more processors of a device, cause the device to perform the method of one or more of Aspects 1-16.

Aspect 40: A device for wireless communication, the device comprising a processing system that includes one or more processors and one or more memories coupled with the one or more processors, the processing system configured to cause the device to perform the method of one or more of Aspects 1-16.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-16.

Aspect 42: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 17-34.

Aspect 43: An apparatus for wireless communication at a device, the apparatus comprising one or more memories and one or more processors coupled to the one or more memories, the one or more processors configured to cause the device to perform the method of one or more of Aspects 17-34.

Aspect 44: An apparatus for wireless communication, the apparatus comprising at least one means for performing the method of one or more of Aspects 17-34.

Aspect 45: A non-transitory computer-readable medium storing code for wireless communication, the code comprising instructions executable by one or more processors to perform the method of one or more of Aspects 17-34.

Aspect 46: A non-transitory computer-readable medium storing a set of instructions for wireless communication, the set of instructions comprising one or more instructions that, when executed by one or more processors of a device, cause the device to perform the method of one or more of Aspects 17-34.

Aspect 47: A device for wireless communication, the device comprising a processing system that includes one or more processors and one or more memories coupled with the one or more processors, the processing system configured to cause the device to perform the method of one or more of Aspects 17-34.

Aspect 48: An apparatus for wireless communication at a device, the apparatus comprising one or more memories and one or more processors coupled to the one or more memories, the one or more processors individually or collectively configured to cause the device to perform the method of one or more of Aspects 17-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first user equipment (UE), comprising:
one or more memories; and
one or more processors, coupled to the one or more memories, configured to cause the first UE to:
generate a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and
transmit the message to a second UE.

2. The apparatus of claim 1, wherein the message further includes information indicating an addition of at least one new sidelink resource reservation to the subset or a removal of an existing sidelink resource reservation from the subset.

3. The apparatus of claim 1, wherein the message excludes information indicating an addition of at least one new sidelink resource reservation to the subset based on whether a previous message transmitted to the second UE included the information indicating the addition of the at least one new sidelink resource reservation to the subset.

4. The apparatus of claim 3, wherein the message excludes the information indicating the addition of the at least one new sidelink resource reservation to the subset further based on whether the at least one new sidelink resource reservation is active.

5. The apparatus of claim 2, wherein the information indicating the addition of the at least one new sidelink resource reservation to the subset or the removal of the existing sidelink resource reservation from the subset indicates one or more of: a reservation ID, a source ID, a destination ID, a cast type, a forwarded before or not status, a reference signal received power (RSRP) measurement, reserved resources associated with a frequency location, a bandwidth and a periodicity, a zone ID, a packet priority of a sidelink communication, a modulation and coding scheme (MCS), a cast type, a communication range specification, geographical zone information, a feedback utilization status of the sidelink communication, or a channel busy ratio (CBR).

6. The apparatus of claim 2, wherein the information that indicates the change to the subset of the set of sidelink resource reservations includes a bitmap in a reservation overview element (ROE) field, and wherein the information indicating the addition of the at least one new sidelink resource reservation to the subset or the removal of the existing sidelink resource reservation from the subset is included in one of multiple reservation detail element (RDE) fields when multiple subsets of the set of sidelink resource reservations are concurrently advertised.

7. The apparatus of claim 1, wherein the set of sidelink reservations include sidelink reservations associated with the first UE and sidelink reservations associated with neighbor UEs that satisfy criteria, wherein the neighbor UEs include the second UE.

8. The apparatus of claim 1, wherein the subset is permitted to be created or deleted only one time for a given set, and the subset cannot be changed, updated, or modified by an addition or a removal of sidelink reservations, and an event of subset deletion or removal is signaled based at least in part via a value change of the corresponding bit in a bitmap.

9. The apparatus of claim 8, wherein a length of the bitmap corresponds to a maximum number of subsets in the set of sidelink reservations, and wherein the set ID in the resource reservation information is incremented based at least in part on a maximum number of subsets being attained and a formation of a new subset being needed due to an addition of at least one new sidelink reservation or a removal or deactivation of at least one existing sidelink reservation.

10. The apparatus of claim 1, wherein the message is transmitted via a dedicated resource with a predefined periodicity, the message is transmitted along with a data transmission, the message is event triggered, or the message is in response to an explicit request by the second UE.

11. The apparatus of claim 1, wherein the one or more processors are configured to cause the first UE to:
receive, from the second UE, a request for missing information based at least in part on the message not including the information indicating the addition of at least one new sidelink resource reservation to the subset or the removal of the existing sidelink resource reservation from the subset; and
transmit, to the second UE, a unicast transmission that indicates the missing information.

12. The apparatus of claim 1, wherein the one or more processors are configured to cause the first UE to:
retransmit or broadcast, in a periodic manner, information indicating an addition of at least one new sidelink resource reservation to the subset or a removal of an existing sidelink resource reservation from the subset.

13. The apparatus of claim 1, wherein the message indicates sidelink reservations for which the first UE is a source or a destination, or the message indicates sidelink reservations for which the second UE is a source or a destination and criteria is satisfied.

14. The apparatus of claim 13, wherein the criteria is satisfied when the first UE has received at least one resource reservation information within a certain time duration from the second UE, a reference signal received power (RSRP) measurement between the first UE and the second UE satisfies a threshold, the first UE and the second UE are in a same zone defined by a zone ID, or the first UE and the second UE are already in some form of sidelink communication.

15. The apparatus of claim 1, wherein the resource reservation information indicates one or more of: a limit on a number of sidelink reservations, a limit on an amount of sidelink reservation resources, a number of sidelink reservations associated with the set of sidelink reservations, a portion of resources used by the set of sidelink reservations, or a setting by the first UE that allows the second UE to determine whether to start or not start new periodic reservations.

16. The apparatus of claim 1, wherein the resource reservation information indicates one or more of: a limit on a number of high priority sidelink reservations, a limit on a number of low priority sidelink reservations, a limit on an amount of high priority sidelink reservation resources, or a limit on an amount of low priority sidelink reservation resources.

17. An apparatus for wireless communication at a second user equipment (UE), comprising:
one or more memories; and
one or more processors, coupled to the one or more memories, configured to cause the second UE to:
receive, from a first UE, a message that indicates sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and
transmit, to the first UE or to a third UE, a sidelink transmission based at least in part on the message.

18. The apparatus of claim 17, wherein the message further includes information indicating an addition of at least one new sidelink resource reservation to the subset or a removal of an existing sidelink resource reservation from the subset.

19. The apparatus of claim 18, wherein the message excludes information indicating an addition of at least one new sidelink resource reservation to the subset based on whether a previous message transmitted to the second UE included the information indicating the addition of the at least one new sidelink resource reservation to the subset.

20. A method of wireless communication performed by a first user equipment (UE), comprising:
generating a message for indicating sidelink resource reservation information, wherein the sidelink resource reservation information includes a set identifier (ID) associated with a set of sidelink resource reservations that are tracked by the first UE, and wherein the resource reservation information further includes information that indicates a change to a subset of the set of sidelink resource reservations; and
transmitting the message to a second UE.
